(19) United States
(12) Patent Application Publication
(10) Pub. No.: US 2016/0014415 A1
(43) Pub. Date: Jan. 14, 2016

(54) METHOD AND APPARATUS FOR PERFORMING WAVE-FRONT PARALLEL ENCODING PROCEDURE WITH CONSTRAINT ON CODING MODE AND/OR QUANTIZATION PARAMETER SELECTION

(71) Applicant: Mediatek Inc., Hsin-Chu (TW)

(72) Inventors: Tung-Hsing Wu, Chiayi City (TW); Han-Liang Chou, Hsinchu County (TW); Kun-Bin Lee, Taipei City (TW)

(21) Appl. No.: 14/792,634

(22) Filed: Jul. 7, 2015

Related U.S. Application Data
(60) Provisional application No. 62/021,786, filed on Jul. 8, 2014.

(51) Int. Cl. H04N 19/124; H04N 19/172; H04N 19/176; H04N 19/182

(52) U.S. Cl. CPC H04N 19/124; H04N 19/182; H04N 19/172; H04N 19/176

(57) ABSTRACT

An encoding method includes following steps: performing a wave-front parallel encoding procedure for encoding pixel data of a frame partition, wherein the frame partition comprises a plurality of block rows, each of the block rows comprises a plurality of blocks, and each of the blocks comprises a plurality of pixels; and imposing constraint on a coding mode selection of a first block of a first block row.

### CROSS REFERENCE TO RELATED APPLICATIONS

This application claims the benefit of U.S. provisional application No. 62/021,786, filed on Jul. 8, 2014 and incorporated herein by reference.

### BACKGROUND

The disclosed embodiments of the present invention relate to video coding, and more particularly, to a method and apparatus for performing a wave-front parallel encoding procedure with constraint on coding mode and/or quantization parameter selection.

The conventional video coding standards generally adopt a block based coding technique to exploit spatial and temporal redundancy. For example, the basic approach is to divide the whole source frame into a plurality of blocks, perform prediction on each block, transform residues of each block using discrete cosine transform, and perform quantization and entropy encoding. Besides, a reconstructed frame is generated in a coding loop to provide reference pixel data used for coding following blocks. For certain video coding standards, in-loop filter(s) may be used for enhancing the image quality of the reconstructed frame. For example, a de-blocking filter is included in an H.264 coding loop.

Concerning the traditional video encoding, the processing order of blocks in the same frame is a raster scan order. Hence, blocks in the same block row are sequentially processed from left to right, and block rows in the same frame are sequentially processed from top to bottom. However, there is dependency between a current encoding block and neighboring encoded blocks. For example, motion vector, coding mode, quantization parameter and/or state/probability of entropy coding of the current encoding block may be determined on the basis of information given from the neighboring encoded blocks. To achieve parallel encoding within one frame, the dependency between each current encoding block and its neighboring encoded blocks should be considered. The wave-front parallel encoding may be employed, thus allowing multiple processing cores to encore multiple blocks concurrently. In H.264, entropy encoding function, however, is not considered for wave-front parallel encoding. Hence, in accordance with the conventional H.264 encoder design, no parallel processing for H.264 entropy encoding is implemented. As a result, more processing cores do not mean higher encoding speed for entropy encoding.

### SUMMARY

In accordance with exemplary embodiments of the present invention, a method and apparatus for performing a wave-front parallel encoding procedure with constraint on coding mode and/or quantization parameter selection are proposed to solve the above-mentioned problem.

According to a first aspect of the present invention, an exemplary encoding method is disclosed. The exemplary encoding method includes: performing a wave-front parallel encoding procedure for encoding pixel data of a frame partition, wherein the frame partition comprises a plurality of block rows, each of the block rows comprises a plurality of blocks, and each of the blocks comprises a plurality of pixels; and imposing constraint on a coding mode selection of a first block of a first block row, wherein a coding mode of the first block of the first block row is selected from at least one first candidate coding mode.

According to a second aspect of the present invention, an exemplary encoding method is disclosed. The exemplary encoding method includes: performing a wave-front parallel encoding procedure for encoding pixel data of a frame partition, wherein the frame partition comprises a plurality of block rows, each of the block rows comprises a plurality of blocks, and each of the blocks comprises a plurality of pixels; and determining the quantization parameter of a first block of a first block row before encoding a second block of a second block row.

According to a third aspect of the present invention, an exemplary encoder is disclosed. The exemplary encoder includes an encoding circuit and a control circuit. The encoding circuit is arranged to perform a wave-front parallel encoding procedure for encoding pixel data of a frame partition, wherein the frame partition comprises a plurality of block rows, each of the block rows comprises a plurality of blocks, and each of the blocks comprises a plurality of pixels. The control circuit is arranged to impose constraint on a coding mode selection of a first block of a first block row, wherein a coding mode of the first block of the first block row is selected from at least one first candidate coding mode.

According to a fourth aspect of the present invention, an exemplary encoder is disclosed. The exemplary encoder includes an encoding circuit and a control circuit. The encoding circuit is arranged to perform a wave-front parallel encoding procedure for encoding pixel data of a frame partition, wherein the frame partition comprises a plurality of block rows, each of the block rows comprises a plurality of blocks, and each of the blocks comprises a plurality of pixels. The control circuit is arranged to determine the quantization parameter of a first block of a first block row before encoding a second block of a second block row.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a video encoder according to an embodiment of the present invention.

FIG. 2 is a diagram illustrating a wave-front parallel encoding procedure according to an embodiment of the present invention.

FIG. 3 is a diagram illustrating different configurations of a frame partition according to an embodiment of the present invention.

FIG. 4 is a block diagram illustrating another video encoder according to an embodiment of the present invention.

FIG. 5 is a diagram illustrating another wave-front parallel encoding procedure according to an embodiment of the present invention.

FIG. 6 is a diagram illustrating yet another wave-front parallel encoding procedure according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The main concept of the present invention is to enable a wave-front parallel encoding mechanism for an entropy encoding function involved in encoding of a frame partition. For example, the proposed wave-front parallel procedure having the entropy encoding function included therein may be employed by an H.264 encoder, thus allowing the entropy encoding of blocks in different block rows to be performed in a parallel manner. In addition to the entropy encoding function, other coding tools may also be included in the proposed wave-front parallel procedure. Hence, each coding tool can benefit from the wave-front parallel encoding mechanism. When entropy encoding with rate control is performed using the wave-front parallel encoding mechanism, acceleration of encoding speed of the entropy encoding can be achieved through using more processing cores. Specifically, no matter whether the rate control is performed at the block level or the frame partition level, the proposed wave-front parallel encoding procedure can be employed to boost the encoding speed of the entropy encoding. Further details of the proposed wave-front parallel encoding mechanism suitable for different coding tools, including an entropy encoding function, are described as below.

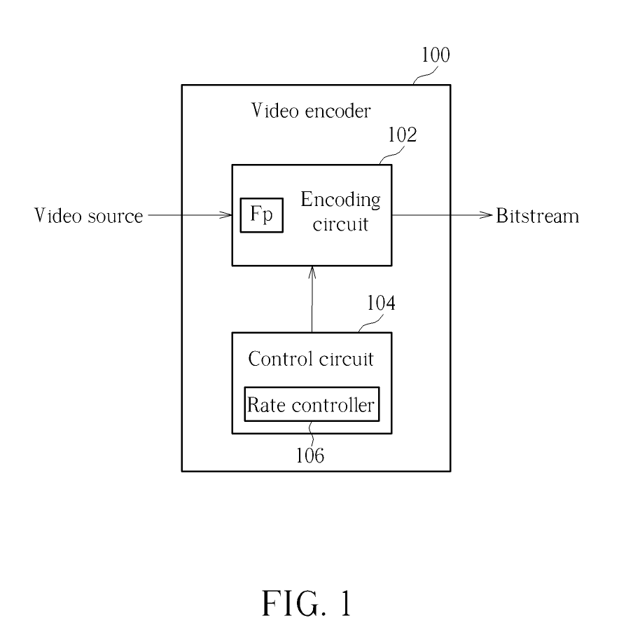

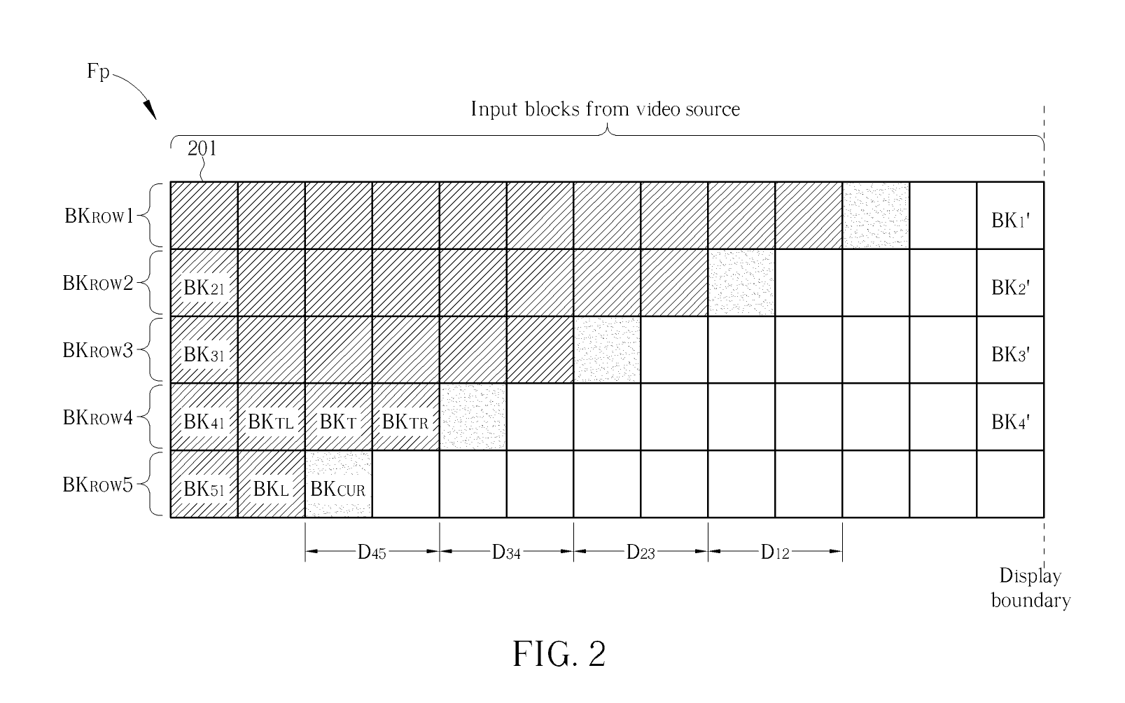

FIG. 1 is a block diagram illustrating a video encoder according to an embodiment of the present invention. The video encoder 100 may include an encoding circuit 102 and a control circuit 104. It should be noted that only the components pertinent to the present invention are shown in FIG. 1. In practice, the video encoder 100 is allowed to include additional component(s) to achieve other function(s). The encoding circuit 102 is arranged to perform a wave-front parallel encoding procedure for encoding pixel data of a frame partition F_{P}. FIG. 2 is a diagram illustrating a wave-front parallel encoding procedure according to an embodiment of the present invention. In this example, the frame partition F_{P} includes a plurality of block rows BK_{ROW}1-BK_{ROW}5, each of the block rows BK_{ROW}1-BK_{ROW}5 includes a plurality of blocks 201, and each of the blocks 201 includes a plurality of pixels. Each of the slant-line shaded blocks represents an encoded block, each of the dot shaded blocks represents a current encoding block, and each of the blank blocks represents a block that is not encoded yet. Since the wave-front parallel encoding procedure is employed, there is more than one current encoding block within the same frame partition F_{P}. There is dependency between one current encoding block and its neighboring encoded blocks. For example, encoding of any current encoding block (e.g., BK_{CUR}) may need the encoded information of a left neighboring encoded block (e.g., BK_{L}), a top-left neighboring encoded block (e.g., BK_{TL}), a top neighboring encoded block (e.g., BK_{T}), and a top-right neighboring encoded block (e.g., BK_{TR}). Hence, the horizontal distance between two current encoding blocks of neighboring block rows should be controlled to be larger than one to ensure that the parallel encoding of the two current encoding blocks can operate successfully. In this example, the horizontal distance D₁₂ between two current encoding blocks of neighboring block rows BK_{ROW}1 and BK_{ROW}2 is equal to two; the horizontal distance D₂₃ between two current encoding blocks of neighboring block rows BK_{ROW}2 and BK_{ROW}3 is equal to two; the horizontal distance D₃₄ between two current encoding blocks of neighboring block rows BK_{ROW}3 and BK_{ROW}4 is equal to two; and the horizontal distance D₄₅ between two current encoding blocks of neighboring block rows BK_{ROW}4 and BK_{ROW}5 is equal to two. In this way, the wave-front parallel encoding procedure can be performed through using multiple processing cores to boost the encoding speed of the frame partition F_{P}. For example, multiple processing cores are used for dealing with encoding of multiple current encoding blocks concurrently.

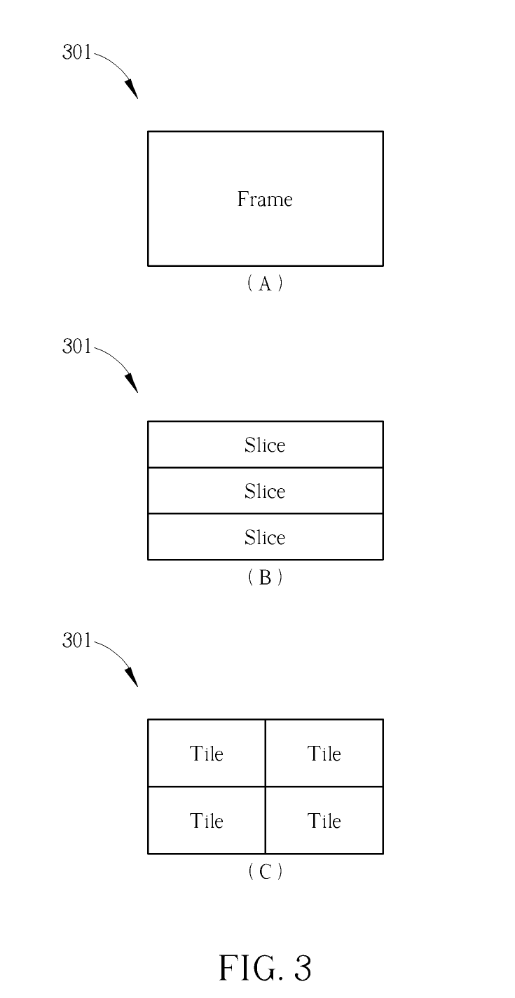

The frame partition F_{P} to be processed/encoded by the encoding circuit 102 employing the proposed wave-front parallel encoding procedure with constraint on the coding mode selection may be a frame 301 as illustrated in sub-diagram (A) of FIG. 3, one slice in the frame 301 as illustrated in sub-diagram (B) of FIG. 3, or one tile in the frame 301 as illustrated in sub-diagram (C) of FIG. 3. It should be noted that the numbers of slices and tiles and the sizes of the slices and tiles shown in FIG. 3 are for illustrative purposes only, and are not meant to be limitations of the present invention.

In contrast to a conventional wave-front parallel encoding procedure without any constraint on a coding mode selection of each block, the proposed wave-front parallel encoding procedure is configured to have constraint on the coding mode selection of certain blocks in the frame partition F_{P} to thereby enable parallel processing of the entropy encoding function applied to blocks in different block rows. In this embodiment, the video encoder 100 has the control circuit 104 designed to impose constraint on a coding mode selection of a specific block of each block row, wherein a coding mode of the specific block of the block row is selected from at least one first candidate coding mode. With regard to an H.264 coding scenario, the at least one first candidate coding mode includes the coding modes which enable prediction of entropy encoding status of the starting block in the next block row. For example, the aforementioned at least one first candidate coding mode may include at least one of an inter mode with residue, an intra mode with residue, and an intra 16×16 mode. In other words, the coding mode of the specific block of the block row may be inter mode with residue, intra mode with residue, or intra 16×16 mode.

The candidate coding modes available for the specific block of the block row is limited so that the entropy encoding status of the starting block in the next block row can be predictable. For example, the block row ends with the specific block. That is, the specific block is the last block of the block row. Since the candidate coding modes available for the last block of the block row is properly constrained, the dependency status of entropy encoding can be predicted between the last block of one block row and a starting block of the next block row, and thus the entropy encoding can be included in the wave-front parallel encoding procedure. In this example, the coding mode selection of the last block BK₁′ of the block row BK_{ROW}1 is limited to one of inter mode with residue, intra mode with residue, and intra 16×16 mode; the coding mode selection of the last block BK₂′ of the block row BK_{ROW}2 is limited to one of inter mode with residue, intra mode with residue, and intra 16×16 mode; the coding mode selection of the last block BK₃′ of the block row BK_{ROW}3 is limited to one of inter mode with residue, intra mode with residue, and intra 16×16 mode; and the coding mode selection of the last block BK₄′ of the block row BK_{ROW}4 is limited to one of inter mode with residue, intra mode with residue, and intra 16×16 mode.

The control circuit 104 may include a rate controller 106 used to determine a quantization parameter used by a quantization function applied to each block of the frame partition F_{P}, where the quantization function may be one of the coding tools included in the wave-front parallel encoding procedure. In a case where the rate control is performed at the frame partition level, the rate controller 106 is arranged to statically determine a quantization parameter for each block included in the frame partition F_{P} before the encoding circuit 102 starts encoding the frame partition F_{P}. For example, according to a target bit budget allocated to the frame partition F_{P}, the rate controller 106 assigns the same quantization parameter to each of the blocks 201 included in the frame partition F_{P}.

In another case where the rate control is performed at the block level, which means different blocks in a frame partition may have different quantization parameters. For example, the rate controller 106 is arranged to dynamically determine a quantization parameter for each block included in the frame partition F_{P} during the encoding of the frame partition F_{P}. According to a target bit budget allocated to the frame partition F_{P}, the rate controller 106 may assign different quantization parameters to blocks 201 included in the frame partition F_{P}. In particular, the quantization parameter (QP) regulates how much the image detail is saved. When the quantization parameter is very small, almost all of the image detail is retained. As the quantization parameter is increased, some of the image detail is aggregated so that the bit rate drops at the price of some increase in distortion and some loss of the quality. Hence, using an adaptive rate control mechanism can lead to improved coding quality.

For example, a differential coding scheme may be employed to encode quantization parameters of the blocks 201. Since a difference between quantization parameters of two successive blocks 201 in the raster scan order is encoded by the entropy encoding, the quantization parameters of certain blocks should be properly controlled to ensure that the dependency status of entropy encoding can be predicted between blocks in different block rows (e.g., the last block of one block row and the starting block of the next block row) and thus the entropy encoding can be included in the wave-front parallel encoding procedure. In this embodiment, the rate controller 106 is further arranged to determine a quantization parameter of a first block before encoding of a second block is started, where encoding of the first block is later than encoding of the second block. For example, the first block is located in a first block row, and the second is located in a second block row different from the first block row. The second block row may be a neighboring block row of the first block row, where the first block row ends with the first block, and the second block row begins with the second block.

Please refer to FIG. 2 again. The block row BK_{ROW}2 begins with the block BK₂₁, the block row BK_{ROW}3 begins with the block BK₃₁, the block row BK_{ROW}4 begins with the block BK₄₁, and the block row BK_{ROW}5 begins with the block BK₅₁. The entropy encoding may encode a difference between quantization parameters of the blocks BK₁′ and BK₂₁ located in adjacent block rows BK_{ROW}1 and BK_{ROW}2. However, according to the wave-front parallel encoding procedure, the encoding of the block BK₁′ (which is the last block in the block row BK_{ROW}1) is later than the encoding of the block BK₂₁ (which is the starting block in the block row BK_{ROW}2 following the block row BK_{ROW}1). Hence, before the encoding circuit 102 starts encoding the block BK₂₁, the control circuit 104 needs to determine the quantization parameter of the block BK₁′ to ensure that entropy encoding of the difference between quantization parameters of blocks BK₂₁ and BK₁′ can be successfully done during encoding of the block BK₂₁ that is started earlier than encoding of the block BK₁′.

Similarly, according to the wave-front parallel encoding procedure, the encoding of the block BK₂′ (which is the last block in the blow row BK_{ROW}2) is later than the encoding of the block BK₃₁ (which is the starting block in the block row BK_{ROW}3 following the block row BK_{ROW}2), the encoding of the block BK₃′ (which is the last block in the block row BK_{ROW}3) is later than the encoding of the block BK₄₁ (which is the starting block in the block row BK_{ROW}4 following the block row BK_{ROW}3), and the encoding of the block BK₄′ (which is the last block in the block row BK_{ROW}4) is later than the encoding of the block BK₅₁ (which is the starting block in the block row BK_{ROW}5 following the block row BK_{ROW}4). Before the encoding circuit 102 starts encoding the block BK₃₁, the control circuit 104 needs to determine the quantization parameter of the block BK₂′ to ensure that entropy encoding of the difference between quantization parameters of the blocks BK₃₁ and BK₂′ can be successfully done during encoding of the block BK₃₁ that is started earlier than encoding of the block BK₂′. Before the encoding circuit 102 starts encoding the block BK₄₁, the control circuit 104 needs to determine the quantization parameter of the block BK₃′ to ensure that entropy encoding of the difference between quantization parameters of the blocks BK₄₁ and BK₃′ can be successfully done during encoding of the block BK₄₁ that is started earlier than encoding of the block BK₃′. Before the encoding circuit 102 starts encoding the block BK₅₁, the control circuit 104 needs to determine the quantization parameter of the block BK₄′ to ensure that entropy encoding of the difference between quantization parameters of the blocks BK₅₁ and BK₄′ can be successfully done during encoding of the block BK₅₁ that is started earlier than encoding of the block BK₄′.

Compared to the context-adaptive binary arithmetic coding (CABAC) entropy encoding, the context-based adaptive variable-length code (CAVLC) entropy encoding has less complexity and data dependency. Hence, the CAVLC entropy encoding is more suitable for the proposed wave-front parallel encoding procedure with constraint on the coding mode selection. In one exemplary design, the encoding circuit 102 is configured to perform the wave-front parallel encoding procedure that includes the CAVLC entropy encoding.

With regard to the frame partition F_{P} shown in FIG. 2, each of the block rows BK_{ROW}1-BK_{ROW}5 is composed of displayable blocks inside a display boundary only. In this embodiment, at least one pixel of each block in a block row is inside the display boundary. For example, the frame partition F_{P} is fully received from a video source (e.g., a camera, a network, or a storage medium), such that all of the blocks within the frame partition F_{P} are input blocks that will be displayed on a display apparatus after bitstream generated from the video encoder 100 is decoded at a video decoder (not shown). As mentioned above, the coding modes of the last blocks BK₁′-BK₄′ (which are input blocks) are limited by the control circuit 104. Hence, it is possible that a coding mode selected for the last block of one block row may not have an optimal coding mode setting. Further, in a case where a block-level rate control mechanism is employed, the quantization parameters of the last blocks BK₁′-BK₄′ are determined by the control circuit 104 before encoding of the last blocks BK₁′-BK₄′ are actually started. Hence, it is possible that the quantization parameter assigned to the last block of one block row may not have an optimal quantization parameter setting. As a result, image quality degradation may occur at or around the last blocks when the last blocks are displayed.

To avoid image quality degradation of blocks displayed on the display apparatus, the proposed wave-front parallel encoding procedure may be applied to a frame partition configured to have extra block(s)/dummy block(s) included in each block row, or to a frame partition configured to have a smaller display boundary. To put it another way, the image quality of blocks displayed on the display apparatus can be ensured by using the proposed wave-front parallel encoding procedure to encode extra block(s)/dummy blocks concatenated to input blocks of each block row that are received from the video source, or by shrinking the display boundary of input blocks of each block row received from the video source.

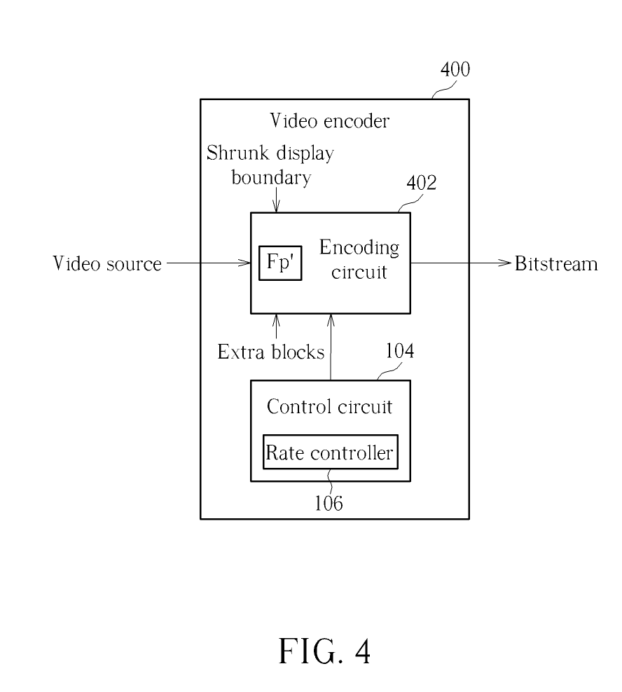

FIG. 4 is a block diagram illustrating another video encoder according to an embodiment of the present invention. The major difference between the video encoders 400 and 100 is the frame partition format or the display boundary setting. Compared to the encoding circuit 102 that performs the proposed wave-front parallel encoding procedure upon the frame partition F_{P} fully received from the video source and fully inside the display boundary, the encoding circuit 402 is arranged to perform the proposed wave-front parallel encoding procedure upon a frame partition F_{P}′ derived from adding extra blocks to a frame partition received from the video source or having a shrunk display boundary. For example, a first part of the frame partition F_{P}′ is composed of input blocks received from the video source, and a second part of the frame partition F_{P}′ is composed of extra blocks/dummy blocks inserted at the encoding circuit 402. For another example, the frame partition F_{P}′ is controlled to have a shrunk display boundary such that a first part of the frame partition F_{P}′ is composed of input blocks received from the video source and categorized as blocks located inside the shrunk display boundary, and a second part of the frame partition F_{P}′ is composed of input blocks received from the video source and categorized as blocks located outside the shrunk display boundary.

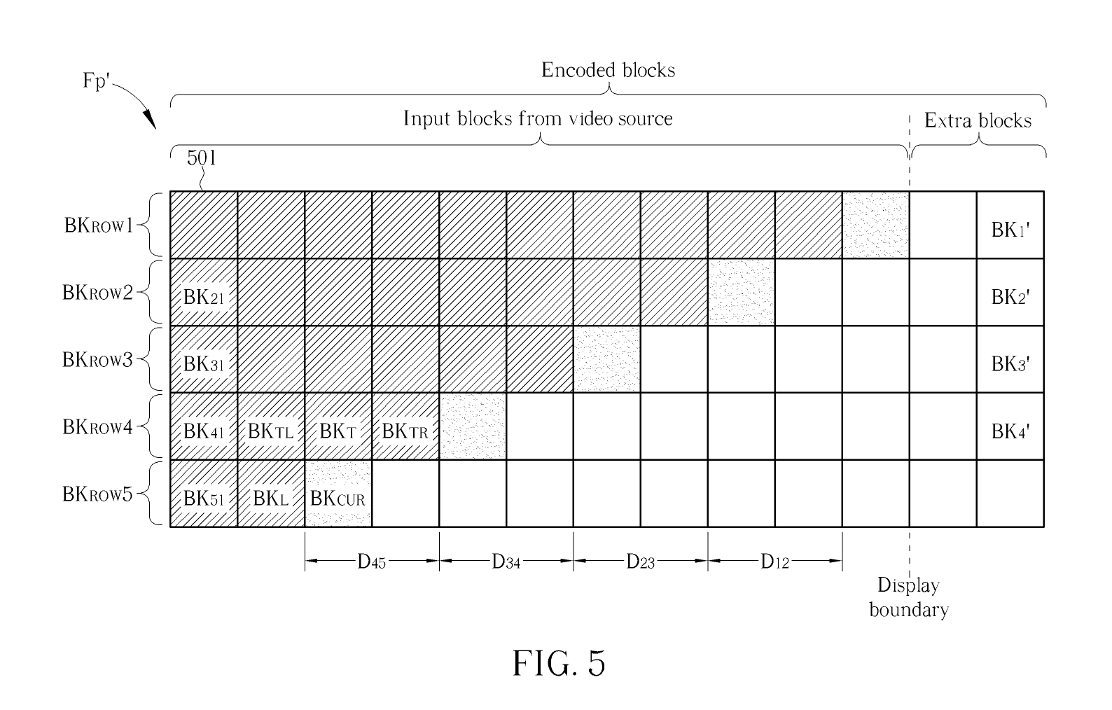

FIG. 5 is a diagram illustrating another wave-front parallel encoding procedure according to an embodiment of the present invention.

In this example, the frame partition F_{P}′ includes a plurality of block rows BK_{ROW}1-BK_{ROW}5, each of the block rows BK_{ROW}1-BK_{ROW}5 includes a plurality of blocks 501, and each of the blocks 501 includes a plurality of pixels. With regard to each of the block rows BK_{ROW}1-BK_{ROW}5, at least one extra block is included therein. Hence, each of the block rows BK_{ROW}1-BK_{ROW}5 shown in FIG. 5 is composed of displayable blocks (i.e., input blocks received from the video source) inside a display boundary and at least one non-displayable block (e.g., extra block(s) inserted at the encoding circuit 402) outside the display boundary. For example, each of the extra blocks may be set by a pre-defined block composed of pixels each having a predetermined pixel value. For another example, each of the extra blocks may be a padding block that is a duplicate of the last input block in the same block row. However, these are for illustrative purposes only, and are not meant to be limitations of the present invention.

The input blocks received from the video source and the extra blocks inserted at the encoding circuit 402 are blocks (denoted as “encoded blocks”) that will be actually encoded by the encoding circuit 402. It should be noted that, as illustrated in FIG. 5, the block row boundary of the encoded blocks is not aligned with the display boundary (e.g., the block row boundary of input blocks received from the video source).

As shown in FIG. 5, the last blocks BK₁′-BK₄′ of the block rows BK_{ROW}1-BK_{ROW}4 are extra blocks that will not be displayed on a display apparatus after the bitstream generated from the video encoder 400 is decoded at a video decoder (not shown). When the proposed wave-front parallel encoding procedure is applied to the frame partition F_{P}′ according to the same aforementioned coding mode selection rule and/or the quantization parameter determination rule applied to the last blocks, the entropy encoding can be included in the wave-front parallel encoding procedure without image quality degradation of the last displayable blocks in the block rows BK_{ROW}1-BK_{ROW}5. Specifically, the coding modes of the last blocks BK₁′-BK₄′ are limited by the control circuit 104, where each of the last blocks BK₁′-BK₄′ is a non-displayable block outside the display boundary. Even though a coding mode selected for the last block of one block row may not have an optimal coding mode setting, the image quality of the last displayable block in the same block row is not affected by the proposed wave-front parallel encoding procedure. Further, in a case where a block-level rate control mechanism is employed, the quantization parameters of the last blocks BK₁′-BK₄′ are determined by the control circuit 104 before encoding of the last blocks BK₁′-BK₄′ are actually started, where each of the last blocks BK₁′-BK₄′ is a non-displayable block outside the display boundary. Even though a quantization parameter determined for the last block of one block row may not have an optimal quantization parameter, the image quality of the last displayable block in the same block row is not affected by the proposed wave-front parallel encoding procedure.

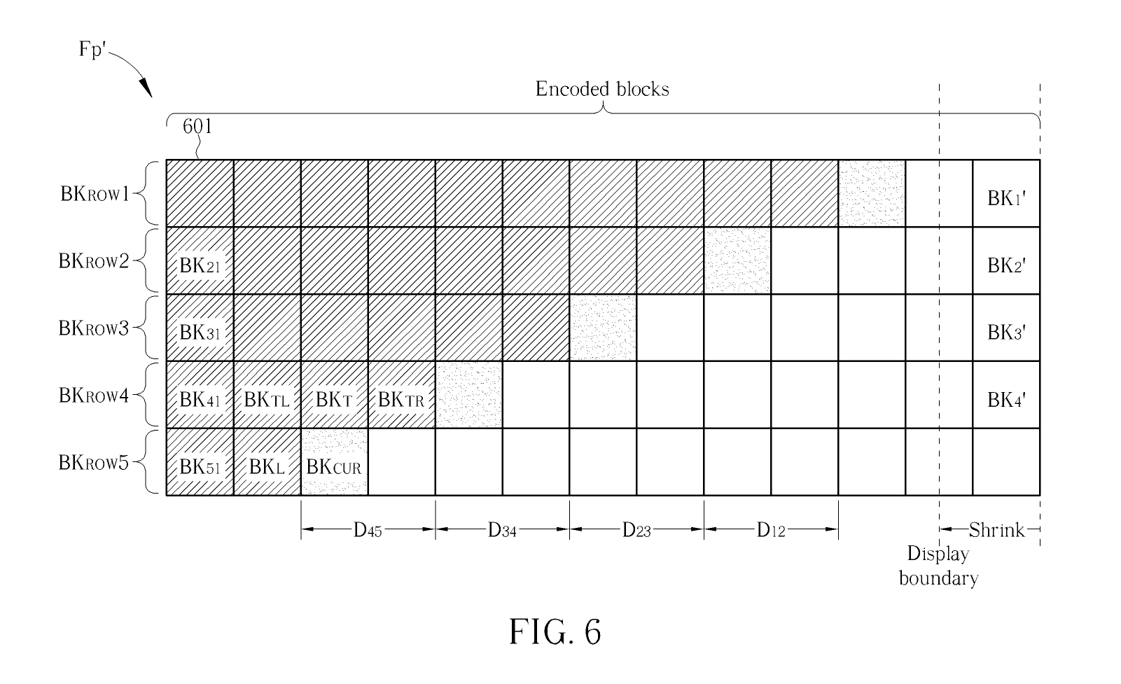

FIG. 6 is a diagram illustrating yet another wave-front parallel encoding procedure according to an embodiment of the present invention. In this example, the frame partition F_{P}′ includes a plurality of block rows BK_{ROW}1-BK_{ROW}5, each of the block rows BK_{ROW}1-BK_{ROW}5 includes a plurality of blocks 601, and each of the blocks 601 includes a plurality of pixels. Suppose that an original display boundary may be aligned with the block row boundary of blocks (denoted as “encoded blocks”) that will be encoded by the encoding circuit 402. In this embodiment, the display boundary shown in FIG. 6 is controlled to shift leftwards, thus resulting in a shrunk display boundary that is not aligned with the block row boundary of encoded blocks. For example, the encoded blocks may include input blocks received from the video source. For another example, the encoded blocks may include input blocks received from the video source and extra blocks inserted at the encoding circuit 402.

With regard to each of the block rows BK_{ROW}1-BK_{ROW}5, at least one encoded block is treated as a non-displayable block outside the shrunk display boundary. Hence, each of the block rows BK_{ROW}1-BK_{ROW}5 shown in FIG. 6 is composed of displayable blocks (i.e., encoded blocks fully or partially located inside the shrunk display boundary) and at least one non-displayable block (e.g., encoded block(s) fully located outside the shrunk display boundary).

As shown in FIG. 6, the last blocks BK₁′-BK₄′ of the block rows BK_{ROW}1-BK_{ROW}4 are encoded blocks that will not be displayed on a display apparatus after the bitstream generated from the video encoder 400 is decoded at a video decoder (not shown). When the proposed wave-front parallel encoding procedure is applied to the frame partition F_{P}′ shown in FIG. 6 according to the same aforementioned coding mode selection rule and/or the quantization parameter determination rule applied to the last blocks, the entropy encoding can be included in the wave-front parallel encoding procedure without image quality degradation of the last displayable blocks in the block rows BK_{ROW}1-BK_{ROW}5. Specifically, the coding modes of the last blocks BK₁′-BK₄′ are limited by the control circuit 104, where each of the last blocks BK₁′-BK₄′ is a non-displayable block outside the shrunk display boundary. Even though a coding mode selected for the last block of one block row may not have an optimal coding mode setting, the image quality of the last displayable block (which may be fully or partially inside the shrunk display boundary, depending upon the actual setting of the shrunk display boundary) in the same block row is not affected by the proposed wave-front parallel encoding procedure. Further, in a case where a block-level rate control mechanism is employed, the quantization parameters of the last blocks BK₁′-BK₄′ are determined by the control circuit 104 before encoding of the last blocks BK₁′-BK₄′ are actually started, where each of the last blocks BK₁′-BK₄′ is a non-displayable block outside the shrunk display boundary. Even though a quantization parameter determined for the last block of one block row may not have an optimal quantization parameter, the image quality of the last displayable block (which may be fully or partially inside the shrunk display boundary, depending upon the actual setting of the shrunk display boundary) in the same block row is not affected by the proposed wave-front parallel encoding procedure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An encoding method comprising:
performing a wave-front parallel encoding procedure for encoding pixel data of a frame partition, wherein the frame partition comprises a plurality of block rows, each of the block rows comprises a plurality of blocks, and each of the blocks comprises a plurality of pixels; and
imposing constraint on a coding mode selection of a first block of a first block row, wherein a coding mode of the first block of the first block row is selected from at least one first candidate coding mode.

2. The encoding method of claim 1, wherein the first block row ends with the first block.

3. The encoding method of claim 2, wherein at least one pixel of each block in the first block row is inside a display boundary.

4. The encoding method of claim 2, wherein the first block row is composed of displayable blocks inside a display boundary and at least one non-displayable block outside the display boundary, and the at least one non-displayable block includes the first block.

5. The encoding method of claim 1, further comprising:
before encoding of a second block is started, determining a quantization parameter of the first block;
wherein encoding of the first block is later than encoding of the second block.

6. The encoding method of claim 5, wherein the second block is located in a second block row different from the first block row.

7. The encoding method of claim 6, wherein the second block row begins with the second block.

8. The encoding method of claim 7, wherein the first block row ends with the first block.

9. The encoding method of claim 5, wherein the first block row is a neighboring block row of the second block row.

10. The encoding method of claim 1, wherein the at least one first candidate coding mode comprises coding modes which enable prediction of entropy encoding status of a second block located in a second block row.

11. The encoding method of claim 10, wherein
the first block row is a neighboring block row of the second block row;
the second block row begins with the second block; and
the first block row ends with the first block.

12. The encoding method of claim 10, wherein the second block is entropy encoded before entropy encoding the first block.

13. The encoding method of claim 1, wherein the wave-front parallel encoding procedure comprises context-based adaptive variable-length code (CAVLC) entropy encoding.

14. The encoding method of claim 1, wherein the frame partition is a frame, one slice in the frame, or one tile in the frame.

15. An encoder comprising:
an encoding circuit, arranged to perform a wave-front parallel encoding procedure for encoding pixel data of a frame partition, wherein the frame partition comprises a plurality of block rows, each of the block rows comprises a plurality of blocks, and each of the blocks comprises a plurality of pixels; and
a control circuit, arranged to impose constraint on a coding mode selection of a first block of a first block row, wherein a coding mode of the first block of the first block row is selected from at least one first candidate coding mode.

16. The encoder of claim 15, wherein the first block row ends with the first block.

17. The encoder of claim 16, wherein at least one pixel of each block in the first block row is inside a display boundary.

18. The encoder of claim 16, wherein the first block row is composed of displayable blocks inside a display boundary and at least one non-displayable block outside the display boundary, and the at least one non-displayable block includes the first block.

19. The encoder of claim 15, wherein the control circuit comprises a rate controller arranged to determine a quantization parameter of the first block before encoding of a second block is started; and encoding of the first block is later than encoding of the second block.

20. The encoder of claim 19, wherein the second block is located in a second block row different from the first block row.

21. The encoder of claim 20, wherein the second block row begins with the second block.

22. The encoder of claim 21, wherein the first block row ends with the first block.

23. The encoder of claim 19, wherein the first block row is a neighboring block row of the second block row.

24. The encoder of claim 15, wherein the at least one first candidate coding mode comprises coding modes which enable prediction of entropy encoding status of a second block located in a second block row.

25. The encoding method of claim 24, wherein
the first block row is a neighboring block row of the second block row;
the second block row begins with the second block; and
the first block row ends with the first block.

26. The encoding method of claim 24, wherein the second block is entropy encoded before entropy encoding the first block.

27. The encoder of claim 15, wherein the wave-front parallel encoding procedure comprises context-based adaptive variable-length code (CAVLC) entropy encoding.

28. The encoder of claim 15, wherein the frame partition is a frame, one slice in the frame, or one tile in the frame.
